(19) United States
(12) Patent Application Publication
(10) Pub. No.: US 2024/0240034 A1
(43) Pub. Date: Jul. 18, 2024

(54) ANTIVIRAL COMPOSITION FOR THE SURFACE TREATMENT OF AN ARTICLE

(71) Applicant: OBERTHUR FIDUCIAIRE SAS, PARIS (FR)

(72) Inventor: Henri ROSSET, Le Pin (FR)

(21) Appl. No.: 18/559,435

(22) PCT Filed: May 13, 2022
(86) PCT No.: PCT/EP2022/063020

§ 371 Date: Nov. 7, 2023

(30) Foreign Application Priority Data
May 17, 2021 (FR) 21 05126

(51) Int. Cl. C09D 5/14; A01N 33/12; A01N 59/16; C08G 73/02

(52) U.S. Cl. CPC C09D 5/14; A01N 33/12; A01N 59/16; C08G 73/0286

(57) ABSTRACT

The invention relates to an antiviral composition for the surface treatment of an article, comprising:
at least one polyamide-polyamine-epichlorohydrin resin, known as PAAE resin, and
one or more biocidal agents including at least one compound based on silver and/or one compound based on quaternary ammonium.

The invention also relates to a process for the surface treatment of an article, in particular a substrate, intended to give it antiviral properties, comprising the application to the surface of said article of one or more compositions comprising at least said PAAE resin and said biocidal agent(s), and also to an article surface-treated via said process.

### TECHNICAL FIELD

The invention relates to a composition for treating the surface of an article, in particular a substrate, notably a sheet, which is capable of giving it antiviral properties. Said article is in particular intended to be touched or handled relatively frequently. It is notably used for manufacturing an information support intended to be handled relatively frequently.

The invention is particularly directed toward proposing a substrate, for example a fibrous substrate intended for the manufacture of banknotes, having improved antiviral surface properties.

### PRIOR ART

In modern societies, an ever increasing quantity of materials or objects, such as supports for transmitting information, is intended to be handled daily and frequently by a large number of people.

As nonlimiting illustrations of these information supports, mention may notably be made of means of payment, such as a banknote, a cheque or a restaurant ticket, an identity document, such as an identity card, a visa, a passport or a driving licence, a lottery ticket, a travel ticket, a tax disc or tax stamp, a playing card, a packaging, a book, a magazine, etc.

However, the users of these objects may be carriers of pathogenic microorganisms, in particular viruses, which may generate epidemic and pandemic diseases with varying degrees of severity, and may therefore be liable to contaminate any support with which they come into contact. In the case where this support is intended to be consecutively handled by one or more other users, it in turn becomes an important vehicle for the dissemination of microorganisms, with respect to other people.

As a medium of exchange in commercial transactions, banknotes are one of the most widely handled information supports in the world and therefore represent a potential vector for the transmission of diseases.

It has already been proposed, in patent application WO 03/084326, to add bacteriostatic and/or bactericidal and fungistatic and/or fungicidal agents to an information support.

Patent application WO 2012/063176 also describes fluid compositions that are capable of forming a coating with antiviral activity, based on naturally occurring virucides, such as monolaurin.

For obvious reasons, optimizing the antiviral properties provided by a surface treatment on these supports is an ongoing objective. In particular, the aim is to achieve good antiviral efficacy against a broad spectrum of viruses.

According to the structure of the virus, two major different types of viruses may be distinguished: viruses lacking an envelope, known as “naked” viruses, which consist of a genome, DNA or RNA and a capsid of viral proteins, and viruses known as “enveloped” viruses, which additionally have an envelope consisting of a double lipid layer in which viral proteins are integrated. The coronavirus family (Coronaviridae), including the SARS-CoV-2 coronavirus responsible for coronavirus disease 2019 (COVID-19), belongs to this second category of viruses.

Consequently, to prevent the risk of contamination linked to the handling of various objects, in particular information supports, intended to be handled frequently by a large number of people, such as banknotes, it is desirable to be able to give the surface of these objects good antiviral properties, preferably antiviral activity against a broad spectrum of viruses, both naked viruses and enveloped viruses.

The present invention is specifically directed toward meeting this need.

### DISCLOSURE OF THE INVENTION

The present invention thus proposes a novel composition for the surface treatment of an article, in particular a substrate, with particularly advantageous antiviral properties.

More particularly, according to a first of its aspects, the invention relates to an antiviral composition for the surface treatment of an article, which is particularly suitable for forming a coating on the surface of an article, comprising:
at least one polyamide-polyamine-epichlorohydrin resin, known as PAAE resin, and
one or more biocidal agents, including at least one compound based on silver, in particular a silver salt such as silver chloride (AgCl) and/or one compound based on quaternary ammonium, in particular a quaternary ammonium salt, which may or may not be polymeric, notably didecyldimethylammonium chloride (DDAC).

Said antiviral composition according to the invention more particularly also comprises at least one binding agent, in particular as defined hereinbelow.

Preferably, a composition according to the invention also comprises at least 3-iodo-2-propynylbutyl carbamate (noted as IPBC) and/or diiodomethyl-p-tolyl sulfone (noted as DIMTS).

Thus, a composition according to the invention preferably uses a combination of biocidal agents comprising:
at least one compound based on silver, in particular a silver salt such as silver chloride (AgCl) and/or one compound based on quaternary ammonium, in particular a quaternary ammonium salt, which is notably nonpolymeric, such as DDAC; and
at least 3-iodo-2-propynylbutyl carbamate (noted as IPBC) and/or diiodomethyl-p-tolyl sulfone (noted as DIMTS).

In the text hereinbelow, a composition according to the invention, comprising at least one PAAE resin and one or more biocidal agents as indicated previously, is denoted as “antiviral treatment composition according to the invention” or more simply “composition according to the invention”.

The term “surface treatment” is intended to denote the application of a composition to the surface of an article, so that the treated surface has the desired antiviral properties. In particular, the surface treatment of an article according to the invention leads to the formation of a localized coating on the surface of said article and/or in the superficial part of the thickness of the article.

Preferably, a surface treatment process according to the invention leads to the formation of a coating located at least at the outer surface of the article, in particular of the substrate, treated according to the invention. In a particular embodiment, the surface treatment according to the invention may lead to the formation of a coating located entirely on the surface of the article, in other words without penetration of the composition into the thickness of the article.

Polyamide-polyamine-epichlorohydrin resins, known by the abbreviation PAAE, are cationic wet-strength resins commonly used in the bulk manufacture of paper substrates, so as to improve their wet strength. These resins are then introduced “in the bulk”, in other words into the fibrous suspension during the production of the paper support.

To the best of the inventors' knowledge, it has never been proposed to use such PAAE resins in a formulation intended for the surface treatment of an article, notably a substrate, for example for the treatment of a fibrous substrate by surfacing, in combination with one or more biocidal agents, in order to improve the antiviral activity of the coating formed.

Surprisingly, as illustrated in the following examples, the inventors have found that the addition according to the invention of a PAAE resin, in an antiviral composition intended for the surface treatment of an article, in other words intended to form an antimicrobial coating, together with one or more biocidal agents as indicated previously, allows the antiviral activity manifested by the surface thus treated to be significantly increased.

Thus, the presence of PAAE resin makes it possible to stimulate/enhance the antiviral activity manifested by the surface treatment composition comprising at least one compound based on silver and/or compound based on quaternary ammonium.

The term “antiviral” or “virucidal” refers to the ability of a compound, a composition or a coating to inhibit the growth of viruses or to kill viruses.

The antiviral coating or composition according to the present invention is more particularly intended for inhibiting and/or killing viruses that are pathogenic to mammals and more particularly to humans.

The use of a PAAE resin according to the invention, together with one or more biocides as considered according to the invention, preferably a combination of biocides as described previously, advantageously affords access to a coating with good antiviral performance, toward both naked viruses and enveloped viruses.

The antiviral activity of a substrate treated according to the invention may be evaluated by standard methods, as described in the following examples, for example against bacteriophage MS2, a virus representative of naked viruses, in accordance with the standard ISO18184:2019-06, and against human coronavirus Hcov-OC43, an enveloped virus representative of the coronavirus family to which SARS-COV2 belongs, in accordance with the standard ASTME 1053.

The invention thus relates, according to another of its aspects, to the use of at least one PAAE resin as an additive for improving the antiviral properties of a composition intended for the surface treatment of an article, notably a substrate, in particular a fibrous substrate, comprising one or more biocides including at least one compound based on silver, in particular a silver salt and/or at least one compound based on quaternary ammonium, in particular a quaternary ammonium salt, such as DDAC.

Advantageously, according to a particular embodiment, an antiviral treatment composition or coating formed according to the invention combines at least one PAAE resin, at least one compound based on silver, in particular a silver salt such as silver chloride and, preferably, at least IPBC and/or DIMTS.

According to another particular embodiment, an antiviral treatment composition or coating formed according to the invention combines at least one PAAE resin, at least one compound based on quaternary ammonium, in particular a quaternary ammonium salt, such as DDAC and, preferably, at least IPBC and/or DIMTS.

As detailed in the text hereinbelow, the compositions according to the invention may be intended for the surface treatment of various articles, notably substrates, in particular sheet substrates, which are more particularly intended to be handled frequently by a large number of people, and are therefore liable to carry pathogenic microorganisms, notably viral microorganisms. This notably concerns sheet substrates for packaging or for manufacturing information supports.

In particular, they may be intended for the surface treatment of a substrate, in particular a sheet, intended for the manufacture of an information support, in particular a fibrous substrate intended for the manufacture of a security document. As examples of such security documents, mention may be made of banknotes, which are handled at least hundreds of times during their circulation period.

The present invention also describes a process for the surface treatment of an article, in particular a substrate, intended to give it antiviral properties, comprising the application to the surface of said article of one or more compositions, comprising at least one PAAE resin and one or more biocides including at least one compound based on silver, in particular a silver salt and/or at least one compound based on quaternary ammonium, in particular a quaternary ammonium salt, such as DDAC.

More particularly, the subject of the invention is a process for treating the surface of an article, in particular a substrate, to give it antiviral properties, involving: applying to the surface of said article one or more compositions, comprising at least one PAAE resin and one or more biocides including at least one compound based on silver, in particular a silver salt and/or at least one compound based on quaternary ammonium, in particular a quaternary ammonium salt, such as DDAC; and forming a coating present at least on the surface of said treated article, comprising at least said PAAE resin and said biocidal agent(s).

As detailed in the text hereinbelow, according to a first embodiment variant, the surface treatment process according to the invention may comprise the application to the surface of said article of a single antiviral treatment composition according to the invention, as defined previously, combining at least said PAAE resin and said abovementioned biocidal agent(s).

The invention also relates to the use of a composition according to the invention, comprising at least one PAAE resin and one or more biocides including at least one compound based on silver, in particular a silver salt and/or at least one compound based on quaternary ammonium, in particular a quaternary ammonium salt, such as DDAC, to give antiviral properties to all or part of the surface of an article, in particular to all or part of the surface of at least one of the faces of a substrate.

According to another embodiment variant, the surface treatment process according to the invention may comprise the successive application of at least two different compositions comprising, taken in combination, at least said PAAE resin and said abovementioned biocide(s), a drying step optionally being performed between two application steps.

Said composition(s) for substrate surface treatment may more particularly be applied by spraying, sizing, impregnating, printing, overprinting on an at least partially printed surface, surfacing, coating or depositing on the surface to be treated.

The invention also relates to a process for forming an antiviral coating on all or part of the surface of at least one of the faces of an article, in particular a substrate, said process comprising the application to the surface of said article of one or more compositions, comprising at least one PAAE resin and one or more biocides including at least one compound based on silver, in particular a silver salt and/or at least one compound based on quaternary ammonium, in particular a quaternary ammonium salt, such as DDAC.

According to another of its aspects, the invention relates to an article surface-treated via a process according to the invention, as defined previously, said article in particular being a substrate, notably in sheet form.

In particular, the invention more particularly relates to a substrate, in particular a sheet, notably intended for the manufacture of an information support, in particular a fibrous substrate intended for the manufacture of a secure document, such as a banknote, provided on at least part of one of its faces with a coating as obtained from an antiviral treatment composition according to the invention, incorporating at least one PAAE resin and one or more biocides including at least one compound based on silver, in particular a silver salt, and/or at least one compound based on quaternary ammonium, in particular a quaternary ammonium salt, such as DDAC.

The invention also relates to a process for manufacturing a substrate as defined previously, comprising at least one step of forming, on all or part of the surface of at least one of the faces of said substrate, a coating incorporating at least said PAAE resin and said biocide(s) under consideration according to the invention, including at least one compound based on silver, in particular a silver salt, and/or at least one compound based on quaternary ammonium, in particular a quaternary ammonium salt, such as DDAC.

Moreover, as detailed in the text hereinbelow, said composition(s) used for the surface treatment according to the invention may comprise one or more additional compounds, notably with regard to their mode of application and intended purpose.

For example, in the case of a composition intended to be applied by surfacing to the surface of a substrate, said composition preferably comprises an aqueous surfacing agent preferably incorporating glycerol.

The antiviral treatment compositions according to the invention may be, for example, compositions, which are notably aqueous, of varnish, notably overprint varnish, ink or lacquer.

A composition according to the invention may contain, in addition to said PAAE resin and said biocide(s), in particular said abovementioned combination of biocidal agents, at least one of the components conventionally considered in this type of coating formulations, for example at least one binding agent, as described in the text hereinbelow.

Other features, variants and advantages of an antiviral treatment composition according to the invention, and of its implementation for the surface treatment of articles, in particular of substrates, will emerge more clearly on reading the following description and examples, given as non-limiting illustrations of the invention.

In the continuation of the text, the expressions “between . . . and . . . ”, “ranging from . . . to . . . ” and “varying from . . . to . . . ” are equivalent and are intended to mean that the limits are included, unless otherwise mentioned.

### Antiviral Treatment Composition

As indicated previously, to achieve particularly advantageous antiviral properties, the invention combines at least one PAAE resin with one or more biocidal agents, including at least one compound based on silver, in particular a silver salt and/or one compound based on quaternary ammonium, in particular DDAC.

### PAAE Resin(s)

A composition according to the invention may comprise one or more polyamide-polyamine-epichlorohydrin resins, known as PAAE resins.

In the text hereinbelow, unless otherwise indicated, the term “PAAE resin” denotes a single PAAE resin or a mixture of at least two PAAE resins.

As indicated previously, polyamide-polyamine-epichlorohydrin resins, also known as “polyamide amine-epichlorohydrin” resins, are commonly used in the paper industry, being introduced into the bulk of the cellulosic fibrous material, so as to give the paper material wet strength.

The PAAE resin used according to the invention may in particular be a polymer of adipic acid, diethylenetriamine and epichlorohydrin.

It may thus be obtained from adipic acid, diethylenetriamine (DETA) and epichlorohydrin. The PAAE resin may be prepared via synthetic routes known to those skilled in the art, by performing a first condensation step between adipic acid and diethylenetriamine, followed by reaction of the polyamide polyamine resin thus formed with epichlorohydrin to form said PAAE resin.

PAAE resins are also commercially available. By way of example, mention may be made of the resin sold under the trade name FennoStrength® XO by the company Kemira.

Preferably, the PAAE resin has a low chloride content. This is notably the case for the resin sold under the reference FennoStrength® XO. Such resins with a low chloride content are particularly advantageous in the field of banknotes, so as to limit the risk of corrosion of security elements, notably magnetic elements, for example security threads, which are sometimes sensitive to corrosion.

An antiviral treatment composition according to the invention may notably comprise from 0.015% to 0.6% by dry weight, in particular from 0.075% to 0.45% by dry weight and more particularly from 0.075% to 0.3% by dry weight of PAAE resin(s) relative to the total weight of said composition.

The term “dry weight”, also known as “weight of active material”, is intended to denote the mass content of said compound, without any volatile solvents in which it is formulated, for example water.

The amount of PAAE resin(s) in a surface treatment composition according to the invention is preferably between 0.24% and 8.82% by dry weight, in particular between 1.2% and 6.66% by dry weight and more particularly from 1.2% to 4.6% relative to the total dry weight of the composition.

The total dry weight of the composition means the sum of the masses of the compounds used in the formulation of said composition, excluding volatile solvents, in particular water. These volatile solvents are eliminated during the formation of the coating according to the invention, after drying of the composition applied to the surface of the article.

The content of a given compound, expressed as a percentage by dry weight relative to the total dry weight of the composition according to the invention, thus corresponds to the mass percentage by dry weight of said compound relative to the dry weight of the coating formed from said composition.

### Biocides

As indicated previously, an antiviral treatment composition according to the invention comprises, as biocidal agent(s), at least one compound based on silver, in particular a silver salt and/or at least one compound based on quaternary ammonium, notably a quaternary ammonium salt, for example didecyldimethylammonium chloride (DDAC).

For the purposes of the invention, the terms “biocidal agent” or “biocide”, equivalent to the terms “antimicrobial agent”, denote, in general, any agent that is effective in regulating and/or inhibiting the growth and/or reducing the density of microorganisms such as viruses, fungi, bacteria, yeasts, etc.

The biocidal agent or combination of biocidal agents under consideration according to the invention advantageously has an antimicrobial effect on viruses, in other words antiviral or virucidal activity, in particular against both naked viruses and enveloped viruses.

Compounds based on silver, in particular silver salts, and compounds based on quaternary ammonium, in particular quaternary ammonium salts, are known as antimicrobial and/or microbicidal agents, in particular as bacteriostatic (or antibacterial) and/or bactericidal agents.

Compounds based on silver with antimicrobial properties are known to those skilled in the art.

They may in particular be silver salts, in particular chosen from silver nitrate, chloride or thiosulfate. Preferably, the silver salt used as an antimicrobial agent according to the invention is silver chloride.

Alternatively, it may be silver in a supported particulate form. Silver (oxidation state zero) is more particularly supported by a particulate inorganic material, for example chosen from zeolites and glasses, notably phosphate glasses.

The particle size of the silver-loaded or silver-doped material is preferably less than 10 μm and more preferably less than 5 μm. The particle size may in particular be measured by SEM imaging or DLS (dynamic light scattering). The particle size may more particularly be defined by the diameter D98, i.e. the diameter such that 98% of the particles by weight are smaller than said diameter.

The loaded content of silver of oxidation state zero in the material notably ranges from 0.5% to 3%, notably from 1.0% to 2.5%, by weight relative to the total loaded weight.

In particular, the silver used as an antimicrobial agent according to the invention is silver supported by a particulate material made of glass, preferably phosphate glass. More precisely, the silver metal is in the form of silver particles in a phosphate glass matrix. This matrix has the advantage of being permeable to Ag⁺ silver ions, thus allowing the passage/mobility of the Ag⁺ silver ions. These Ag⁺ ions, which have bactericidal activity, are generated by placing silver of oxidation state zero, dispersed in the surface treatment composition, in contact with ambient humidity or during contamination, for example by droplets notably from sputum.

A material of this type is notably sold under the name Ultrafresh CA16 by the company Thomson Research Associates Inc.

Compounds based on quaternary ammonium, in particular quaternary ammonium salts, are also known as antimicrobial and/or microbicidal agents, and more particularly as bacteriostatic (or antibacterial) and/or bactericidal and/or fungistatic (or antifungal) and/or fungicidal agents.

More particularly, these are polymeric or nonpolymeric quaternary ammonium salts.

Quaternary ammonium salts generally comprise at least one quaternary ammonium cation with a suitable anion.

The cation more particularly has the following structure:

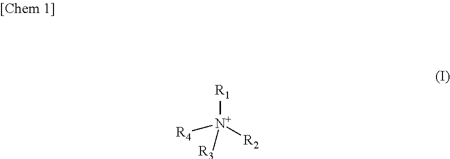

where R₁, R₂, R₃ and R₄ may be of different nature. For example, R₁, R₂, R₃ and R₄ may be chosen, independently of each other, from alkyl, aryl, alkylaryl, arylalkyl, cycloalkyl, aromatic or nonaromatic heterocyclic or alkenyl groups, said groups possibly being substituted or unsubstituted, linear or branched, and optionally interrupted with one or more heteroatoms, for example with one or more oxygen atoms, or with one or more phosphinate groups.

Alternatively, two or more of the groups R₁, R₂, R₃ and R₄ may form, together with the nitrogen atom supporting them, a substituted or unsubstituted heterocyclic ring.

According to a particular embodiment, the groups R₁, R₂, R₃ and R₄ are alkyl groups, preferably linear, in particular C₁ to C₂₀ groups.

The groups R₁, R₂, R₃ and R₄ together comprise at least four carbon atoms. In particular, the total number of carbon atoms in the groups R₁, R₂, R₃ and R₄ may be at least 10. Preferably, at least one of the groups R₁, R₂, R₃ and R₄, in particular two from among R₁, R₂, R₃ and R₄, comprise from 6 to 20 carbon atoms, in particular from 8 to 18 carbon atoms.

The anion of the quaternary ammonium salt may notably be chosen from halide anions, for example chloride, fluoride, bromide or iodide, and sulfonate anions. Preferably, the anion of the quaternary ammonium salt may be a chloride.

The nonpolymeric quaternary ammonium salts may more particularly have the following formula:

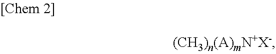

in which A is as defined previously for R₁, R₂, R₃ and R₄; X⁻ is an anion as defined previously; n is an integer between 1 and 3, preferably 2 or 3; m is an integer between 1 and 3, preferably 1 or 2, with the proviso that the sum n+m is 4. When m is 2 or 3, the groups A may be identical or different, in particular identical.

Preferably, the quaternary ammonium salt used as an antimicrobial agent according to the invention may be of the formula (CH₃)ₙ(A)ₘN⁺X⁻, in which n is 2 and m is 2 and A, which may be identical or different, are as defined above for R₁, R₂, R₃ and R₄.

In particular, A, which may be identical or different, in particular identical, may represent linear C₆ to C₂₀, in particular C₈ to C₁₈, notably C₈ to C₁₂ alkyl groups.

By way of example, didecyldimethylammonium chloride (DDAC), dioctyldimethylammonium chloride and octyldecyldimethylammonium chloride may be mentioned.

According to a particular embodiment, an antiviral treatment composition according to the invention uses at least didecyldimethylammonium chloride (DDAC).

The compound based on quaternary ammonium may also be a polymeric quaternary ammonium salt, i.e. a compound whose chemical formula comprises a repetition of “quaternary ammonium” units.

Such a “polymeric” quaternary ammonium salt may be derived from at least one compound of formula (I) in which at least one from among R₁, R₂, R₃ and R₄ bears a polymerizable function, in particular an ethylenically unsaturated function chosen more particularly from (meth)acrylate and allylic functions.

In particular, the compound based on quaternary ammonium may be obtained by polymerization of at least one quaternary ammonium salt of the abovementioned formula (I), in which two from among R₁, R₂, R₃ and R₄ are groups bearing an allylic function, and in particular are allylic groups; the others preferably being alkyl groups, in particular C₁ to C₆, notably C₁ to C₄ groups, in particular methyl groups.

According to a particular embodiment, the compound based on quaternary ammonium is a diallyldialkylammonium chloride polymer. In particular, it may be the diallyldimethylammonium chloride polymer, noted as polyDADMAC.

PolyDADMAC may be synthesized by radical polymerization of DADMAC in the presence of a peroxide catalyst; or it may be commercially available.

Thus, a composition according to the invention may comprise at least one biocidal agent chosen from silver salts, in particular silver chloride, silver in a supported particulate form, in particular supported by a particulate inorganic material, for example glass and preferably phosphate glass; polymeric or nonpolymeric quaternary ammonium salts, in particular chosen from didecyldimethylammonium chloride (DDAC) and diallyldialkylammonium chloride polymers, for example diallyldimethylammonium chloride polymer (polyDADMAC), and mixtures thereof.

An antiviral treatment composition according to the invention preferably comprises said biocidal compound(s) based on silver, in particular of the silver salt type, and/or said biocidal compound(s) based on quaternary ammonium, in particular of the quaternary ammonium salt type, in an amount of from 0.004% to 1% by dry weight, in particular from 0.004% to 0.75% by dry weight, relative to the total weight of the treatment composition.

Preferably, said biocidal compound(s) based on silver, in particular of the silver salt type, are present in an amount of from 0.004% to 0.04% by dry weight, in particular from 0.004% to 0.02% by dry weight, relative to the total weight of the treatment composition.

Preferably, said biocidal compound(s) based on quaternary ammonium, in particular as defined previously, for instance DDAC, are present in an amount of from 0.05% to 1% by dry weight, in particular from 0.25% to 0.75% by dry weight, relative to the total weight of the treatment composition.

Said biocidal compound(s) based on silver ions, in particular of the silver salt type, and/or said biocidal compound(s) based on quaternary ammonium, in particular as defined previously, preferably represent from 0.07% to 18% by dry weight, in particular from 0.07% to 14% by dry weight, relative to the total dry weight of the antiviral composition.

Preferably, said biocidal compound(s) based on silver, in particular of the silver salt type, are present in an amount of from 0.07% to 0.7% by dry weight, in particular from 0.07% to 0.35% by dry weight, relative to the total dry weight of the antiviral composition.

Preferably, said biocidal compound(s) based on quaternary ammonium, in particular as defined previously, for example DDAC, are present in an amount of from 0.8% to 18% by dry weight, in particular from 4% to 14% by dry weight, relative to the total dry weight of the antiviral composition.

As indicated previously, according to a preferred embodiment, a composition according to the invention comprises a combination of biocides comprising:
at least one compound based on silver and/or compound based on quaternary ammonium, in particular as defined previously; and
at least 3-iodo-2-propynylbutyl carbamate (IPBC) and/or at least diiodomethyl-p-tolyl sulfone (DIMTS).

IPBC and DIMTS are known more particularly as fungistatic and/or fungicidal agents.

Thus, an antiviral treatment composition according to the invention preferably combines:
at least one PAAE resin;
at least one bacteriostatic and/or bactericidal agent chosen from compounds based on silver, in particular silver salts such as silver chloride, compounds based on quaternary ammonium, in particular polymeric or nonpolymeric quaternary ammonium salts, such as DDAC or polyDADMAC, and mixtures thereof;
at least one fungistatic and/or fungicidal agent chosen from 3-iodo-2-propynylbutyl carbamate (IPBC), diiodomethyl-p-tolyl sulfone (DIMTS) and mixtures thereof. 3-Iodo-2-propynylbutyl carbamate, also known as “iodopropynyl butylcarbamate” and denoted as “IPBC”, and diiodomethyl-p-tolyl sulfone, also known as “p-[(diiodomethyl)sulfonyl]toluene” and denoted as “DINTS”, are notably known in general as fungistatic and/or fungicidal agents and algistatic or algicidal agents. They are generally in the form of an aqueous dispersion.

Such biocidal agents are commercially available.

An antiviral treatment composition according to the invention preferably comprises IPBC and/or DIMTS in a proportion of from 0.1% to 0.6% by dry weight, in particular from 0.2% to 0.6% by dry weight, relative to the total weight of the composition.

In particular, the amount of IPBC and/or DIMTS in a composition according to the invention may represent between 1.9% and 10.5% by dry weight, in particular between 1.9% and 3.77% by dry weight, relative to the total dry weight of the composition.

According to a particular embodiment, an antiviral treatment composition according to the invention comprises at least one compound based on silver, in particular a silver salt, notably silver chloride and at least IPBC.

According to another particular embodiment, a composition according to the invention comprises at least one compound based on quaternary ammonium, notably a quaternary ammonium salt, in particular DDAC and at least IPBC.

According to another particular embodiment, a composition according to the invention comprises at least one silver salt, in particular silver chloride, and at least DIMTS.

According to another particular embodiment, a composition according to the invention comprises at least one compound based on quaternary ammonium, in particular a quaternary ammonium salt, notably DDAC, and at least DIMTS.

It is understood that a composition according to the invention may comprise one or more additional biocides, other than the specific compounds mentioned above.

These biocidal compounds may be of diverse nature, provided that they do not impact the effect of the combination according to the invention of said PAAE resin with said abovementioned compound(s) based on silver and/or compound(s) based on quaternary ammonium, possibly combined with IPBC and/or DIMTS.

Needless to say, these agents are moreover selected for their harmlessness to humans under the conditions of use according to the invention.

These additional biocides may be chosen from bacteriostatic, bactericidal, fungistatic, yeasticidal, fungicidal and/or virucidal agents.

They may include, for example, compounds based on isothiazoline or isothiazolone derivatives, compounds based on chitosan or chitin derivatives, zinc zeolite, triclosan and mixtures thereof.

A composition according to the invention may in particular comprise one or more ancillary virucides, for example of natural origin.

As representatives of viruses that are pathogenic to humans and which may be considered according to the invention, mention may be made more particularly of coronaviruses (for example SARS-COV2, HcoV-OC43 or HcoV-229E), retroviruses, cytomegaloviruses, rotaviruses, paramyxoviruses, polioviruses, hantaviruses, coxsackie viruses, encephalomyocarditis virus, picornaviruses, including rhinoviruses, and DNA or RNA viruses, notably the flaviviridae, AIDS virus, Ebola virus, influenza viruses, smallpox virus, yellow fever virus, hepatitis C virus, herpes viruses, Epstein-Barr virus, varicella-zoster virus, rubella virus, and simian virus 40 or SV40.

The term “naturally occurring virucide” refers to any virucide which already exists in nature or which may be synthesized from naturally occurring compounds.

The virucides of natural origin that may be used in the context of the present invention may thus be obtained either by extraction and purification from a natural medium containing them, or by synthesis from natural compounds.

By way of example of such virucides, mention may notably be made of monolaurin, which may be obtained by synthesis from glycerol and lauric acid.

For the purpose of the invention, the term monolaurin is intended to denote both naturally occurring monolaurin and that obtained synthetically from glycerol and lauric acid.

According to a particular embodiment, the naturally occurring virucide may notably be chosen from monolaurin, lactoferrin and essential oils with antiviral activity, for example essential oil of laurel.

According to a particular embodiment, an antiviral treatment composition according to the invention does not comprise any biocidal agent other than said compound(s) based on silver ions and/or based on quaternary ammonium, optionally combined with IPBC or DIMTS as described previously.

Advantageously, the effect of potentiating antiviral activity, obtained due to the addition of said PAAE resin, allows the use of a reduced total amount of biocidal agents, notably virucidal agents.

According to a particular embodiment, an antiviral treatment composition according to the invention comprises a total dry weight content of biocidal agents, in particular under consideration according to the invention, of less than or equal to 1% in particular between 0.1% and 0.7% by weight, relative to the total weight of said composition.

In particular, said biocidal agent(s) under consideration according to the invention, in particular said silver and/or quaternary ammonium salt(s), optionally combined with IPBC and/or DIMTS, preferably represent from 1.5% to 15% by dry weight, in particular from 1.5% to 10% by dry weight, relative to the total dry weight of said composition.

According to a particular embodiment, a surface treatment composition according to the invention may comprise at least:
from 0.24% to 8.82% by dry weight, in particular from 1.2% to 6.66% by dry weight and more particularly from 1.2% to 4.6% by dry weight of one or more PAAE resins;
from 0.07% to 18% by dry weight, in particular from 0.07% to 14% by dry weight, of one or more bacteriostatic and/or bactericidal agents chosen from compounds based on silver, in particular silver salts such as silver chloride, compounds based on quaternary ammonium, in particular polymeric or nonpolymeric quaternary ammonium salts such as DDAC and polyDADMAC; and mixtures thereof;
from 1.9% to 10.5% by dry weight, in particular from 1.9% to 3.77% by dry weight, of one or more fungistatic and/or fungicidal agents chosen from 3-iodo-2-propynylbutyl carbamate (IPBC), diiodomethyl-p-tolyl sulfone (DIMTS) and mixtures thereof, the contents being expressed relative to the total dry weight of said composition.

### Surface Treatment Composition Formulation

It is understood that the formulation of an antiviral treatment composition according to the invention is adjusted with regard to the application for which it is intended, for example as a varnish, notably an overprint varnish, ink, lacquer, etc., and to the mode of application under consideration for treating the substrate surface with said composition, as detailed in the text hereinbelow.

A composition according to the invention is preferably a fluid composition, in particular having a viscosity, measured at 60° C., of between 30 mPa·s and 40 Pa·s, in particular between 50 mPa·s and 25 Pa·s.

The viscosity of a composition may be measured by conventional methods. The choice of the appropriate measurement method and equipment, notably with regard to the viscosity scale of the composition under consideration, clearly falls within the competence of a person skilled in the art.

For example, for a composition with a viscosity clearly below 2 Pa·s, a Brookfield viscometer with spindle No. 2 at 100 rpm (ISO 2555) is the preferred measuring device.

This viscosity may be adjusted with regard to the purpose of the composition and its mode of application.

The viscosity of the treatment composition according to the invention may notably be adjusted via the nature and/or amount of the solvent medium associated with the compounds required according to the invention, or via the addition and adjustment of the amount of binder(s) if present in a composition according to the invention.

### Solvent Medium

An antiviral treatment composition according to the invention may comprise an aqueous or organic solvent medium. The solvent medium is notably chosen with regard to the type of composition intended.

The solvent medium may be a one-phase or two-phase medium. For example, a solvent medium according to the invention may be in the form of an oil-in-water or water-in-oil emulsion.

In general, a composition according to the invention may comprise, as solvent medium, water, an organic solvent, an oil or a mixture thereof.

According to a particular embodiment, a composition according to the invention is an aqueous composition, the solvent medium preferably being water. In particular, it may comprise said PAAE resin and said biocidal agent(s) considered according to the invention in water.

### Additional Compounds

An antiviral treatment composition according to the invention may also comprise one or more additional components, in particular chosen from the compounds conventionally used in the type of composition under consideration, provided that their presence does not affect the antiviral properties conferred by the combination of said PAAE resin and of said biocidal agent(s) according to the invention.

The nature of said additional compound(s) is chosen with regard to the type of composition under consideration and its mode of application.

Preferably, a composition according to the invention comprises at least one binder, in particular a polymer binder.

According to one particular embodiment, a composition according to the invention also comprises at least one pigment.

The binders are in particular compounds conventionally used in paper, varnish and/or ink processing compositions. Their function therein is generally to ensure the dispersion of particles such as pigments if present in the composition and to contribute, after drying and/or crosslinking of the composition applied to the surface of a support, to the formation of a film of sufficient hardness to ensure the durability of said support.

The binders may notably be chosen from resins, waxes, gums and mixtures thereof.

The resins may notably be chosen from cycloaliphatic epoxy, acrylic, vinyl, ketone, polyester, polyurethane and aldehyde resins.

As waxes that may be used according to the invention, mention may be made of:
plant waxes such as carnauba, candelilla, ouricury, Japanese, cocoa butter or cork or sugarcane fiber waxes,
mineral waxes, for example paraffin wax, petroleum jelly wax, lignite wax, microcrystalline waxes or ozokerites,
synthetic waxes, including polyolefin waxes, notably polyethylene waxes, and waxes obtained by Fisher-Tropsch synthesis,
silicone waxes, in particular substituted linear polysiloxanes; mention may be made, for example, of polyether silicone waxes, alkyl or alkoxy-dimethicones containing from 16 to 45 carbon atoms, alkyl methicones such as C₃₀-C₄₅ alkyl methicone sold under the trade name AMS C 30 by Dow Corning,
hydrogenated oils,
and/or mixtures thereof.

As illustrations of waxes that are suitable for the invention, mention may be made especially of hydrocarbon-based waxes, for instance beeswax, lanolin wax, Chinese insect waxes, rice bran wax, carnauba wax, candelilla wax, ouricury wax, esparto grass wax, berry wax, shellac wax, Japan wax and sumac wax; montan wax, orange wax and lemon wax, microcrystalline waxes, paraffins and ozokerite; polyethylene waxes, the waxes obtained by Fischer-Tropsch synthesis and waxy copolymers, and also esters thereof.

The gums may be chosen, for example, from acacia gums, tragacanth gums, cassia gums, gutte gums, shellac gums, sandarac gums, mastic gums or resin gums.

According to a particular embodiment, a composition according to the invention, in particular an aqueous composition according to the invention, comprises at least one binder, notably a hydrophilic binder, in particular a polymeric binder, and more particularly a binder chosen from polyalcohols, preferably polyvinyl alcohols (PVA).

An antiviral treatment composition according to the invention preferably comprises from 1% to 40% by dry weight, in particular from 2% to 20% by dry weight, of one or more binders, in particular of the type such as PVA, relative to the total weight of the composition.

Preferably, said binder(s), in particular of the PVA type, are present in a dry weight mass proportion of between 30% and 90% by dry weight, in particular between 50% and 80% by dry weight, relative to the total dry weight of said composition.

A composition according to the invention may also comprise at least one humectant. This is notably the case for a composition intended to be applied by surfacing on the surface of a substrate.

A humectant is a compound that is capable of giving a moisturizing or hygroscopic effect.

As representative of these humectants, polyol-type compounds may be particularly considered in the context of the present invention, for instance glycerol, propylene glycol, polyethylene glycol, butylene glycol, glyceryl triacetate or sorbitol.

According to another embodiment variant, the humectant under consideration is chosen from the following compounds: pidolic acid (PCA) and derivatives thereof (arginine PCA, copper PCA, ethylhexyl PCA, lauryl PCA, magnesium PCA, sodium PCA, zinc PCA, etc.), calcium gluconate, fructose, glucose, isomalt, lactose, maltitol, mannitol, polydextrose, sorbitol, sucrose or xylitol, glycyrrhizic acid and derivatives thereof, histidine, hyaluronic acid and its salts such as sodium hyaluronate, silk, keratin or soybean hydrolyzates, phytanetriol, silk or urea.

According to a preferred embodiment variant, the humectant is chosen from polyols and more particularly glycerol.

An antiviral treatment composition according to the invention may preferably comprise from 0.5% to 4% by dry weight, for example from 1% to 3% by dry weight, of humectant(s), notably glycerol, relative to the total weight thereof.

According to a particular embodiment, an antiviral treatment composition according to the invention may comprise, in a solvent medium, in particular in an aqueous solvent medium:
at least one PAAE resin,
one or more biocides, including at least one compound based on silver, in particular a silver salt and/or one compound based on quaternary ammonium, in particular a quaternary ammonium salt, as described previously, in particular at least silver chloride and/or DDAC, and, preferably, at least one fungistatic and/or fungicidal agent chosen from 3-iodo-2-propynylbutyl carbamate (IPBC), diiodomethyl-p-tolyl sulfone (DIMTS) and mixtures thereof;
at least one binder, in particular polyvinyl alcohol (PVA);
optionally at least one additive, in particular at least one humectant such as glycerol.

Preferably, a surface treatment composition according to the invention comprises:
from 0.24% to 8.82% by dry weight, in particular from 1.2% to 6.66% by dry weight and more preferentially from 1.2% to 4.6% by dry weight of one or more PAAE resins;
from 0.07% to 18% by dry weight, in particular from 0.07% to 14% by dry weight, of at least one biocide chosen from compounds based on silver, in particular a silver salt, compounds based on quaternary ammonium, in particular quaternary ammonium salts, and mixtures thereof, in particular at least silver chloride and/or DDAC;
optionally, from 1.9% to 10.5% by dry weight, in particular from 1.9% to 3.77% by dry weight of at least one fungistatic and/or fungicidal agent chosen from IPBC and/or DIMTS;
from 30% to 90% by dry weight, in particular from 50% to 80% by dry weight, of one or more binders, notably of the PVA type;
the percentages being expressed relative to the total dry weight of said composition.

According to a particular embodiment, the antiviral treatment composition is an aqueous composition, in particular an aqueous surfacing composition. It preferably comprises at least one humectant, notably glycerol.

### Surface Treatment Process

As indicated previously, an antiviral composition according to the invention is intended for the surface treatment of an article.

The articles or objects under consideration according to the invention are notably objects or articles liable to convey viruses, and thus articles intended to be touched or handled relatively frequently.

For the purposes of the invention, an article intended to be handled relatively frequently is an article handled at least twice manually by the same individual or at least two different individuals. Manual handling may consist of at least one touch, for example a grasp, by at least one part of the hand.

These may be substrates, notably intended for manufacturing an information support, for example banknotes or cards such as smart cards, or for packaging; plastic objects, for instance computer keyboards and mice, touch screens, telephone keyboards, screens and handsets, children's toys, medical or health care instructions, nails, musical instruments, work clothes, tools, furnishing fabrics, handles, buttons, packaging.

Said object is made, for example, of a material chosen from glass, paper, cardboard, plastic, textile, etc.

According to a particular embodiment, the invention relates to the surface treatment of a substrate, in particular in the form of a sheet.

The substrate treated according to the invention may be of varied nature.

The substrate under consideration according to the invention may be a porous substrate, in particular fibrous, and more particularly a paper based on fibers known to those skilled in the art, for example cellulose-based fibers (in particular cotton fibers) and/or natural organic fibers other than cellulose-based and/or synthetic fibers, for example polyester or polyamide fibers, and/or optionally mineral fibers, for example glass fibers.

In particular, the substrate, notably of paper type, has a basis weight of between 10 g/m² and 300 g/m², more particularly between 50 g/m² and 150 g/m², or even between 65 g/m² and 150 g/m². The basis weight can be measured via conventional methods, for example according to the standard ISO 536:2019.

According to one particular embodiment, the substrate under consideration according to the invention, in particular in the form of a sheet, is based on cellulose-based fibres.

According to another embodiment, the substrate under consideration according to the invention, in particular in the form of a sheet, is based on natural organic fibers other than cellulose-based fibers.

According to yet another embodiment, the substrate under consideration according to the invention, in particular in the form of a sheet, is based on plastic materials, notably synthetic fibers.

The substrate may be a plastic film, notably a bi-stretched polyethylene-based film such as the Polyart® material sold by the company Arjobex. More particularly, it may be a sheet including a coextruded support, made from at least one polymer material, for example including a core layer and at least one skin layer, the core layer including voids.

The synthetic substrate may also be made of BOPP (bi-oriented polypropylene), in particular a BOPP-based film, notably for banknotes. Such films are sold, for example, under the names Guardian by CCL Secure and Safeguard by the company De La Rue.

The substrate may also be a multilayer substrate, which is notably laminated or laminate bonded. Said multilayer substrate in particular comprises at least one layer based on cellulosic or plastic materials as described previously.

The synthetic substrate may in particular be a multilayer paper-plastic hybrid substrate, for instance paper-plastic-paper or plastic-paper-plastic, such as the substrates for security documents sold under the names EverFit by the Banque de France, Hybrid by the Company Louisenthal, Durasafe by the Company Landqart.

According to yet another particular embodiment, the substrate under consideration according to the invention is based on mineral fibers.

As indicated previously, the substrate under consideration according to the invention may be notably intended for the preparation of an information support, notably an information support intended to be handled relatively frequently.

The information support under consideration according to the invention may be a passport, an identity card, a driving licence, an access card, a loyalty card, a photocopying card, a canteen card, a playing card, a collector's card, a means of payment, notably a payment card, a banknote, a voucher or a receipt, a ticket for access to cultural or sporting events, a certificate of authenticity, or even a packaging, a book, a geographical map, a label, an envelope or a magazine.

The present invention is most particularly applicable to the field of security documents, in particular banknotes.

The substrate under consideration according to the invention may thus be a substrate for a security document, in particular a substrate, notably in sheet form, intended for the manufacture of banknotes.

The invention thus relates to an information support, in particular a security document, notably a banknote, including a substrate treated according to the invention.

The substrate for a security document may include a watermark, and also any other customary first, second or third level security elements.

Among the security elements, some can be detected by eye, in daylight or artificial light, without the use of any particular apparatus. These additional security elements include, for example, colored fibers or planchettes, or totally or partially printed or metallized wires.

These are referred to as first-level security elements.

Other types of security elements can only be detected using a relatively simple apparatus, such as an ultraviolet (UV) or infrared (IR) emitting lamp. These security elements include, for example, fibers, planchettes, strips, threads or particles. These security elements may or may not be visible to the naked eye, for example being luminescent under the illumination of a Wood lamp emitting at a wavelength of 365 nm. These security elements are referred to as second-level elements.

Other types of security elements require more sophisticated apparatus for their detection. For example, these security elements are capable of generating a specific signal when subjected, simultaneously or otherwise, to one or more external sources of excitation. Automatic detection of the signal allows the document to be authenticated, if necessary. These security elements include, for example, tracers in the form of active materials, particles or fibres, which are capable of generating a specific signal when these tracers are subjected to optronic, electrical, magnetic or electromagnetic excitation. These security elements are referred to as third-level elements.

The security element(s) present in the security document according to the invention may have first-, second- or third-level security features.

As indicated previously, the process according to the invention is a surface treatment process. In other words, it is intended to form a coating (film or layer) comprising the compounds required according to the invention, located on the surface of said article and/or in the superficial part of the thickness of the article.

The surface treatment process according to the invention may thus comprise the penetration of said composition(s) used into the superficial part of the substrate thickness. Preferably, said composition(s) for surface treatment according to the invention penetrate into the substrate to less than 15% of its thickness, in particular to less than 10% of its thickness.

The surface treatment process according to the invention is consequently distinguished from “bulk” treatments, which are directed toward incorporating one or more compounds into the bulk of the substrate, usually at the manufacturing stage, for example into the fibrous suspension during the production of the paper support.

Preferably, the surface treatment process according to the invention results in a coating present at least on the surface of said treated article, preferably only on the surface of said article (without penetration).

In particular, the process according to the invention does not comprise any steps for forming one or more layers superimposed on the antiviral coating formed according to the invention comprising at least said PAAE resin and said biocidal agent(s).

Thus, the article treated according to the invention has said surface coating on at least one of its faces; in other words, said antiviral coating forms at least part of the outer surface of the article treated according to the invention.

The surface treatment process according to the invention proceeds more particularly by applying, to the surface to be treated of said article, one or more compositions, said composition(s) comprising at least said PAAE resin and at least said biocidal agent(s) under consideration according to the invention, followed by a drying step.

The coating formed according to the invention may be obtained via the application of an antiviral treatment composition according to the invention as described previously, in particular a single antiviral treatment composition according to the invention, or, alternatively, by the successive application of at least two different compositions.

Thus, according to one particular embodiment, the antiviral treatment process according to the invention comprises the application of an antiviral treatment composition according to the invention, as defined above, comprising at least said PAAE resin and at least said biocide(s) including at least one compound based on silver and/or compound based on quaternary ammonium, for instance silver chloride and/or DDAC, followed by a drying step.

In another particular embodiment, the antiviral treatment process according to the invention comprises the successive application of at least two different compositions, said compositions comprising, taken in combination, at least said PAAE resin and at least said biocide(s) under consideration according to the invention, a drying step optionally being performed between two application steps, followed by a drying step.

In the case of the use of at least two different compositions for the antiviral treatment according to the invention, each of the compositions may have the features as indicated previously for a composition according to the invention, in particular in terms of the nature of the solvent medium and any additional compounds present.

It is understood that the conditions under which the compositions are used are adjusted to allow the formation of a coating, as obtained from a single antiviral treatment composition according to the invention, said coating incorporating all the compounds required according to the invention to lead to the manifestation of the desired effect in terms of potentiation of the antiviral activity by said PAAE resin.

Said composition(s) may be applied to the surface of said article, in particular of said substrate, by spraying, sizing, impregnating, printing, for example by offset printing, by rotogravure, by flexography; overprinting on an at least partially printed surface, for example by flexographic overprinting; surfacing, coating or depositing on the surface to be treated.

It is understood that the mode of application of said composition(s) for the surface treatment according to the invention is adjusted with regard to the nature of the article whose surface is to be treated.

Preferably, said composition(s), in particular for application to the surface of a substrate, in particular a fibrous substrate, are applied by surfacing, sizing or coating.

Any device that allows such treatments to be performed may be used to apply the compositions, such as impregnators, size presses, air knife coaters, doctor blade coaters, curtain coaters, gravure coaters (rotogravure), screen printers and flexographic printers.

The treatment may be localized on part of the surface of the article, or applied to the entire surface of the article. For the treatment of a substrate, in particular a sheet, the treatment may be localized on part of at least one of the substrate faces and, in general, more particularly on the face intended to be touched or handled.

In general, a drying step is performed after application of said composition(s) to the surface of the article, this drying step being intended notably to remove the solvent(s) present in said composition(s).

The antiviral treatment composition according to the invention may constitute, for example, a composition, notably an aqueous composition, of varnish, notably overprint varnish, ink, lacquer or paint.

Depending notably on the nature of the binder(s) present in the composition, it may be, for example, a cellulose, polyurethane or acrylic varnish or ink.

Preferably, when treating the surface of a substrate, in particular as described previously, the treatment is performed on the two opposite sides of the substrate, in particular the sheet substrate.

According to a particular embodiment, the process for the surface treatment of a substrate according to the invention, in particular a fibrous substrate, for instance in the form of a sheet of paper, may comprise the deposition on at least one of the faces, in particular on both opposite faces of said substrate, preferably by surfacing, sizing or coating, of an antiviral treatment composition according to the invention, preferably an aqueous composition as described previously.

The deposit may be produced, for example, using a sizing press.

The fibrous substrate may have undergone a prior treatment, notably impregnation, surfacing, sizing or spreading, notably coating, prior to application of the composition according to the invention.

According to an embodiment variant, the surface treatment process may comprise the successive deposition, preferably by surfacing, sizing or coating, of two compositions, one comprising at least said biocidal agent or said combination of biocidal agents under consideration according to the invention, and the other comprising at least said PAAE resin, a drying step optionally being performed between two deposition steps.

The deposits may be produced, for example, using a sizing press.

The examples given below are presented as nonlimiting illustrations of the invention.

### EXAMPLE 1

### Preparation of Treated Papers

All the substrates are prepared from a sheet of paper which may be suitable as a paper for manufacturing a banknote.

The sheet of paper is formed on a “round” paper machine with a wire including a pattern allowing a watermark to be made, as follows:
A cotton fiber pulp is suspended in water and refined at 60° C. Shoepper-Riegler,
A wet strength agent is added, about 2.5% by dry weight of a poly(amide-amine-epichlorohydrin) resin, expressed relative to the cotton fibers,
Iridescent planchettes are also introduced into this suspension;
When the sheet is formed, a window thread is introduced using known techniques, so that it appears in certain windows on the paper surface; and
The sheet is dried at about 100° C.

The substrates thus prepared are successively treated, in a sizing press, with formulations 1 and 2 as indicated in Table 1 below.

The formulations are prepared by mixing the various compounds in water. The contents are indicated as weight of active material or “dry weight” relative to the total weight of each of the formulations.

They are applied successively to both sides of the paper substrate using a sizing press, followed by drying at 105° C. for 10 minutes.

TABLE 1

| Formulations | CC1 | CC2 | I1 | I2 |
|---|---|---|---|---|
| Formulation No. 1 | % dry weight | | | |
| PVA 28-99* 10% annealed | 1.50 | 1.50 | 1.50 | 1.50 |
| PVA 25-88* 10% annealed | 2.40 | 2.40 | 2.40 | 2.40 |
| IPBC (20% solution) | 0.52 | — | 0.52 | 0.52 |
| AgCl (solution containing 4% AgCl) | 0.01 | — | 0.01 | 0.01 |
| Glycerol | 1.20 | 1.20 | 1.20 | 1.20 |
| Formulation No. 2 | % dry weight | | | |
| PVA 28-99* 10% annealed | 4.00 | 4.00 | 4.00 | 4.00 |
| PAAE (15%) | — | 0.33 | 0.17 | 0.33 |
| Glycerol | 2.20 | 2.20 | 2.20 | 2.20 |
| Viscosity at 60° C.⁽¹⁾ | 28.3 | 33.8 | 28.8 | 33.8 |

*for PVAs, the first two digits give the viscosity at 4% and the last two the degree of hydrolysis in %.
⁽¹⁾viscosity measured using a Brookfield viscometer with spindle No. 2 at 100 rpm (ISO 2555).

### EXAMPLE 2

### Evaluation of the Antiviral Activity

The antiviral activity of all the treated substrates is evaluated as follows.

### Antiviral Activity Against Bacteriophage MS2

The test of antiviral activity against bacteriophage MS2, a bacterial virus of the naked virus family, is based on the standard ISO18184:2019-06.

The principle is as follows: MS2 phages are deposited on the supports to be tested, then the number of active MS2 phages is evaluated a first time at t=0, just after placing the phages in contact with the tested support, then a second time after 18 hours of placing in contact.

To evaluate the number of active MS2 phages on the supports to be tested at a given time, these supports are placed in the presence of particular bacteria which have the property of being hosts to MS2 phages: the measurement of the number of lysis areas or viral plates (or PFU for “plaque-forming unit”) after culture then allows the desired amount of MS2 phages to be determined.

An antiphage activity (denoted as A), defined as follows, may thus be deduced:

$$A = log ( {C}_{18} ) - log ( {E}_{18} )$$

where C₁₈ is the average number of viral plaques (PFU) obtained over three tests on an untreated control sample (inactive polyether sulfone (PES));
and E₁₈ is the average number of viral plaques (PFU) obtained over three tests, after 18 hours of placing in contact with each of the supports treated according to Example 1.

The antiviral activity results obtained for each of the supports treated according to Example 1 are collated in Table 2 below.

### Antiviral Activity Against Human Coronavirus Hcov-OC43

The test of the antiviral activity against the human coronavirus Hcov-OC43, an enveloped virus representing the family of coronaviruses to which SARS-COV2 belongs, is based on the standard ASTM E 1053.

### Cell Culture Infectivity Test

Human coronavirus Hcov-OC43 was propagated and counted using the Most Probable Number (MPN) method, using the human ileocaecal colorectal adenocarcinoma cell line HCT-8 (ATCC CCL-244) as the host. The cells were grown in cell culture flasks in 6-well plates.

For the counting, the virus was counted as infectious units according to the assay methodology described in Standard Method 9510 (APHA, 2012 equivalent to EPA/600/R-95/178 and EPA/600/4/84/013 updated).

Briefly, aliquots of a virus-containing sample were inoculated onto freshly prepared monolayers of HCT8 cells (approximately 90% confluence). The cells were then incubated in dMEM (Dulbecco's Modified Eagle's medium); 2% foetal calf serum medium (FBS, Mediatech, USA) at 35° C. and 5% CO₂ for 10-14 days. The cells were regularly monitored under the microscope for signs of degeneration. Cells showing signs of infectivity in the flasks (cytopathic effects, CPE) were counted as positive (+) and those without any CPE as negative (−). The most probable number of infectious viruses in a sample was then calculated using the MPNCALC software (version 0.0.0.23).

For the experiments, frozen virus stock (typically 1×10⁸ IU/ml) was rapidly thawed in a water bath at 35° C. The viral suspension contained 2% FBS and was used within 15 minutes of thawing. The viral suspension was counted by making tenfold serial dilutions in PBS and then inoculated onto HCT8 cells as described above.

### Evaluation of Treated Paper Samples

The evaluation test was adapted from ASTM protocol E 1053 (“Standard Practice to Assess Virucidal Activity of Chemicals Intended for Disinfection of Inanimate, Nonporous Environmental Surfaces”).

Specifically, the test papers were cut into 25 mm square sections. Three sections of each of the treated test papers and two sections of a reference paper (inactive cotton paper) were placed in sterile 100 mm diameter Petri dishes. 100 ml of the viral suspension were applied uniformly to the surface of each of the paper sections to be evaluated; the inoculum was applied at least 5 mm away from the edges of the sample. The inoculum was left to dry for one hour and the Petri dishes were covered and incubated for a further 4 hours at 20-22° C. in a biological safety chamber (the total contact time was 5 hours). Then, each of the samples (three treated paper sections and two control sections) were transferred to a 50 ml conical-bottomed centrifuge tube (Corning, USA) containing 10 ml of sterile D/E neutralizing broth. The collected samples were placed on an orbital shaker and shaken at low speed for 15 minutes. Subsequently, tenfold dilutions of the suspensions were made in PBS. The number of viable (infectious) virus units in the samples was determined using the Most Probable Number (MPN) method described previously.

The antiviral activity is defined as follows:

$$A = log ( {MPN}_{control} ) - log ( {MPN}_{treated )} \qquad [ Math 1 ]$$

with MPN the average over the samples evaluated of the Most Probable Number of Viral Infectious Units determined as described previously after a contact time of 5 hours, for the control paper (MPN_{control}) and the treated test paper (MPN_{treated}).

The results are presented in Table 2 below:

TABLE 2

| Treated paper | | CC1 | CC2 | I1 | I2 |
|---|---|---|---|---|---|
| Antiviral activity against the | A (log) | 0.41 log | 0.04 log | 0.64 log | 0.84 log |
| bacteriophage MS2 | % decrease in PFU | 61.44% | 8.85% | 77.02% | 85.67% |
| Antiviral activity against the | A (log) | 4.2 log | 1.71 log | 4.2 log | 4.2 log |
| coronavirus Hcov-OC43 | % decrease in MPN | >99.999% | 99.70% | >99.999% | >99.999% |

The antiviral activity of the combination of biocides AgCl and IPBC seems too strong to enable differentiation between the results obtained with the papers treated according to the invention I1 and I2 and the noncompliant paper CC1. 100% mortality of the Hcov-OC43 coronavirus was thus obtained after 5 hours of contact time.

The antiviral activity tests on the bacteriophage MS2 show the effect of the presence of PAAE resin on the potentiation of the antiviral activity. Thus, paper treated according to the invention I1 shows significantly improved antiviral activity against bacteriophage MS2, compared with noncompliant paper CC1 whose surfacing treatment does not include the use of a PAAE resin.

This antiviral efficacy is further enhanced by the use of a higher PAAE resin content (I2 treated paper).

I1 paper tested against the coronaviruses SARS-COV2 and HcoV-229E according to a protocol adapted from the standard ISO 21702:2019 showed antiviral activities of 1.6 log and 2.5 log, respectively.

1. An antiviral composition which is suitable for forming a coating on the surface of an article, comprising:
at least one polyamide-polyamine-epichlorohydrin resin, known as PAAE resin, and
one or more biocidal agents including at least one compound based on silver and/or one compound based on quaternary ammonium.

2. The composition as claimed in claim 1, in which said PAAE resin is formed from adipic acid, diethylenetriamine and epichlorohydrin.

3. The composition as claimed in claim 1, in which said PAAE resin(s) represent from 0.24% to 8.82% by dry weight relative to the total dry weight of said composition.

4. The composition as claimed in claim 1, comprising at least one biocidal agent chosen from silver salts, silver in a supported particulate form; polymeric or nonpolymeric quaternary ammonium salts; and mixtures thereof.

5. The composition as claimed in claim 1, in which said compound(s) based on silver and/or said compound(s) based on quaternary ammonium represent from 0.07% to 18% by dry weight, relative to the total dry weight of said composition.

6. The composition as claimed in claim 1, said composition comprising at least 3-iodo-2-propynylbutyl carbamate (IPBC) and/or diiodomethyl-p-tolyl sulfone (DIMTS).

7. The composition as claimed in claim 1, comprising at least one compound based on silver and at least IPBC.

8. The composition as claimed in claim 1, said composition comprising at least one binder.

9. The composition as claimed in claim 1, said composition comprising at least one aqueous or organic solvent medium.

10. The composition as claimed in claim 1, said composition comprising at least one humectant.

11. A process for the surface treatment of an article intended to give it antiviral properties, comprising the application to the surface of said article of one or more compositions, comprising:
at least one polyamide-polyamine-epichlorohydrin resin, known as PAAE resin; and
one or more biocidal agents including at least one compound based on silver and/or one compound based on quaternary ammonium,
and forming a coating present at least on the surface of said treated article comprising at least said PAAE resin and said biocidal agent(s).

12. The process as claimed in claim 11, the composition or at least one of the compositions also comprising at least one binder.

13. The process as claimed in claim 11, comprising the application to the surface of said article of a single antiviral composition which is suitable for forming a coating on the surface of an article, comprising:
at least one polyamide-polyamine-epichlorohydrin resin, known as PAAE resin, and
one or more biocidal agents including at least one compound based on silver and/or one compound based on quaternary ammonium.

14. The process as claimed in claim 11, comprising the successive application of at least two different compositions comprising, taken in combination, at least said PAAE resin and said biocidal agent(s).

15. The process as claimed in claim 11, in which said composition(s) are applied by spraying, sizing, impregnating, printing; overprinting on an at least partially printed surface; surfacing, coating or depositing on the surface to be treated.

16. An article surface-treated via a process as defined in claim 11.

17. The article as claimed in claim 16, said article being a substrate intended for the manufacture of an information support.

18. An information support including a substrate as defined in claim 17.

19. A method of improving the antiviral properties of a composition intended for the surface treatment of an article, comprising one or more biocides including at least one compound based on silver and/or at least one compound based on quaternary ammonium, using at least one polyamide-polyamine-epichlorohydrin resin as an additive.
